(19) United States
(12) Patent Application Publication
(10) Pub. No.: US 2014/0037018 A1
(43) Pub. Date: Feb. 6, 2014

(54) OFDM RECEIVER WITH DISTORTION COMPENSATION FEATURE, AND SIGNAL PROCESSING METHOD THEREOF

(71) Applicant: SAMSUNG ELECTRO-MECHANICS CO., LTD., Gyunggi-do (KR)

(72) Inventor: Jae Wook KWON, Gyunggi-do (KR)

(73) Assignee: SAMSUNG ELECTRO-MECHANICS CO., LTD., Gyunggi-do (KR)

(21) Appl. No.: 13/660,616

(22) Filed: Oct. 25, 2012

(30) Foreign Application Priority Data
Aug. 6, 2012 (KR) 10-2012-0085880

(51) Int. Cl. H04L 27/28

(52) U.S. Cl. 375/260

(57) ABSTRACT

There are provided an OFDM receiver with a distortion compensation feature and a signal processing method thereof. The OFDM receiver may include: an RF receiving unit converting an RF OFDM signal received from an OFDM transmitter into an OFDM signal; a distortion compensation unit including a plurality of preset compensation functions for respective pieces of data among a plurality of pieces of characteristic identification information data for identifying distortion characteristic functions of a power amplifier included in the OFDM transmitter and compensating for distortions of the OFDM signal by using a compensation function corresponding to a respective piece of the characteristic identification information included in the OFDM signal; and an OFDM receiving unit processing the OFDM signal.

### CROSS-REFERENCE TO RELATED APPLICATIONS

This application claims the priority of Korean Patent Application No. 10-2012-0085880 filed on Aug. 6, 2012, in the Korean Intellectual Property Office, the disclosure of which is incorporated herein by reference.

### BACKGROUND OF THE INVENTION

1. Field of the Invention

The present invention relates to an orthogonal frequency division multiplexing (OFDM) receiver capable of simply compensating for distortions of an OFDM signal in the OFDM receiver using distortion characteristics of a power amplifier included in an OFDM transmitter, and a signal processing method thereof.

2. Description of the Related Art

Generally, orthogonal frequency division multiplexing (OFDM) has been adopted in various wireless communication standards due to having characteristics suitable for broadband communications. In particular, long term evolution (LTE) and WiFi technologies have been popularized due to a sudden increase in the popularity of smart phones and thus, the use of the OFDM technique has rapidly increased.

However, while OFDM has characteristics suitable for broadband communications, it has a defect of a higher peak to average power ratio (PAPR) than other types of communication modulation. Herein, the PAPR largely appears due to a considerably high peak occurring when each sub-carrier is in-phase in the OFDM signal transmitting a plurality of sub-carriers.

When a high PAPR occurs, efficiency of a power amplifier is degraded, cell coverage is reduced, and throughput is reduced due to distortions in a transmitted signal.

Generally, as a technique for reducing PAPR, various techniques such as clipping, partial transmit sequence (PTS), selected mapping (SLM), companding, and the like may be used. The companding technique may relieve the PAPR without distortions of signals and side information. Hereinafter, “side information” refers to information other than pure data.

The OFMD system using the companding technique according to the related art includes an OFDM transmitter and an OFDM receiver having a separate circuit block for companding.

The OFDM transmitter performs a compounding process for pre-compressing the OFDM signal at a front end of the power amplifier to prevent the OFDM signal from being distorted in the power amplifier.

In addition, the OFDM receiver reverses the companding process performed in the OFDM transmitter, that is, performs a decompanding process of expanding the OFDM signal using an RF receiving circuit unit to recover original data from the OFDM signal received in the OFDM receiver.

However, the OFDM system according to the related art as described above necessarily includes a separate companding processor for performing the companding process and a separate decompanding processor for performing the decompanding process, which thereby increases the complexity of a system, thereby causing a delay in the signals and increasing system implementation costs.

The following Related Art Document relates to an apparatus and a method for reconstructing signals distorted by amplitude limitation and does not disclose technical matters of compensating for distortions of an OFDM signal in an OFDM receiver using distortion characteristics of a power amplifier included in an OFDM transmitter.

[Related Art Document]

Korean Patent Laid-Open Publication No. 10-2009-0013910

### SUMMARY OF THE INVENTION

An aspect of the present invention provides an OFDM receiver having a distortion compensation feature capable of simply compensating for distortions of an OFDM signal in an OFDM receiver using distortion characteristics of a power amplifier included in an OFDM transmitter, and a signal processing method thereof.

According to an aspect of the present invention, there is provided an orthogonal frequency division multiplexing (OFDM) receiver, including: an RF receiving unit converting an RF OFDM signal received from an OFDM transmitter into an OFDM signal; a distortion compensation unit including a plurality of preset compensation functions for respective pieces of data among a plurality of pieces of characteristic identification information data for identifying distortion characteristic functions of a power amplifier included in the OFDM transmitter and compensating for distortions of the OFDM signal from the RF receiving unit by using a compensation function corresponding to a respective piece of data of the characteristic identification information data included in the OFDM signal from the RF receiving unit among the plurality of compensation functions; and an OFDM receiving unit processing the OFDM signal of which distortions contained therein are compensated by the distortion compensation unit.

The OFDM signal received in the RF receiving unit may include a single corresponding characteristic identification information datum among the plurality of pieces of characteristic identification information data for identifying the distortion characteristic functions of the power amplifier included in the OFDM transmitter.

The compensation function may be set to an inverse function of the distortion characteristic function of the power amplifier, and the distortion compensation unit may compensate for distortions by multiplying the compensation function by the OFDM signal from the RF receiving unit.

The distortion compensation unit may have the plurality of pieces of characteristic identification information data for identifying the distortion characteristics of various power amplifiers applicable to the OFDM transmitter and a codebook having the plurality of compensation functions respectively corresponding to the plurality of pieces of characteristic identification information data.

The OFDM receiver may be included in an OFDM base station receiving an RF OFDM signal from the OFDM transmitter.

According to another aspect of the present invention, there is provided a signal processing method of an OFDM receiver, including: (a) converting an RF OFDM signal received from an OFDM transmitter into an OFDM signal; (b) detecting a plurality of pieces of characteristic identification information data included in the received OFDM signal so as to recognize a type of distortion characteristic of a power amplifier included in the OFDM transmitter; (c) calling a preset compensation function so as to correspond to the detected pieces of characteristic identification information data; and (d) compensating for distortions of the received OFDM signal by using the called compensation function.

The signal processing method may further include: performing OFDM processing on the distortion-compensated OFDM signal.

The received OFDM signal may include a single corresponding characteristic identification information datum among the plurality of pieces of characteristic identification information data for identifying distortion characteristic functions of the power amplifier included in the OFDM transmitter.

The compensation function may be set to an inverse function of the distortion characteristic function of the power amplifier, and in operation (d), the distortions may be compensated by multiplying the compensation function by the received OFDM signal.

Operation (d) may be performed using the plurality of pieces of characteristic identification information data for identifying the distortion characteristics of various power amplifiers applicable to the OFDM transmitter and a codebook having the plurality of compensation functions respectively corresponding to the plurality of pieces of characteristic identification information data.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates block diagrams of an OFDM transmitter and an OFDM receiver according to an embodiment of the present invention;

FIG. 2 is a flow chart illustrating a signal processing method of an OFDM receiver according to the embodiment of the present invention;

FIG. 3 is a waveform diagram of an OFDM signal according to the embodiment of the present invention; and

FIG. 4 is a graph illustrating distortion characteristic functions and compensation functions according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements maybe exaggerated for clarity, and the same reference numerals will be used throughout to designate the same or like elements.

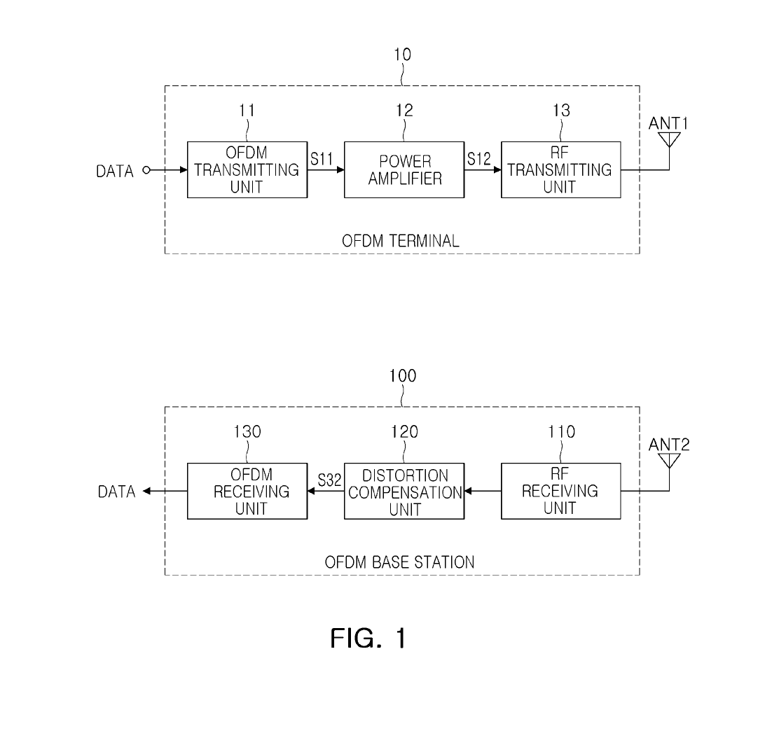

FIG. 1 illustrates a block diagram of an OFDM transmitter and a block diagram of an OFDM receiver according to an embodiment of the present invention.

Referring to FIG. 1, the OFDM system according to the embodiment of the present invention may include an OFDM transmitter 10 and an OFDM receiver 100.

The OFDM transmitter 10 may include an OFDM transmitting unit 11 OFDM-processing data to be transmitted, a power amplifier 12 amplifying power of an OFDM signal from the OFDM transmitting unit 11, and an RF transmitting unit 13 converting the OFDM signal from the power amplifier 12 into an RF OFDM signal and transmitting the RF OFDM signal.

In addition, the OFDM transmitting unit 11 includes one distortion characteristic function corresponding to distortion characteristics of the power amplifier adopted for a current OFDM transmitter among a plurality of distortion characteristic functions in the OFDM signal so as to identify the distortion characteristics of the power amplifier.

Further, referring to FIG. 1, the OFDM receiver 100 according to the embodiment of the present invention may include an RF receiving unit 110 converting the RF OFDM signal received from the OFDM transmitter into the OFDM signal, a distortion compensation unit 120 including a plurality of preset compensation functions for each of a plurality of pieces of characteristic identification information data for identifying the distortion characteristic functions of the power amplifier included in the OFDM transmitter and compensating for the distortions of the OFDM signal from the

RF receiving unit 110 by using compensation functions corresponding to the characteristic identification information included in the OFDM signal from the RF receiving unit 110 among the plurality of compensation functions, and an OFDM receiving unit 130 processing the OFDM signal of which distortions contained therein are compensated by the distortion compensation unit 120.

In this case, the RF receiving unit 110 may convert the RF OFDM signal received from the OFDM transmitter into the OFDM signal.

In addition, the distortion compensation unit 120 may include the plurality of preset compensation functions for respective pieces of data among the plurality of pieces of characteristic identification information data for identifying the distortion characteristic functions of the power amplifier included in the OFDM transmitter and may compensate for the distortions included in the OFDM signal from the RF receiving unit 110 by using a compensation function corresponding to the characteristic identification information data included in the OFDM signal from the RF receiving unit 110 among the plurality of pieces of characteristic identification information data.

Further, the OFDM receiving unit 130 may receive and process the OFDM signal of which distortions contained therein are compensated by the distortion compensation unit 120 so as to recover original data from the OFDM signal.

In addition, referring to FIG. 1, the OFDM signal output from the RF receiving circuit unit 110 may include a single characteristic identification information datum corresponding to the distortion characteristics of the power amplifier adopted for the current OFDM transmitter from among the plurality of pieces of characteristic identification information data for identifying the distortion characteristic functions of the power amplifier included in the OFDM transmitter.

For example, when the distortion characteristics of the power amplifier applied to the OFDM transmitter are classified into type A distortion characteristics, type B distortion characteristics, and type C distortion characteristics, the characteristic identification information capable of identifying the type A distortion characteristics, the type B distortion characteristics, and the type C distortion characteristics may be added to the OFDM signal.

Further, referring to FIG. 1, the compensation function may be set to be an inverse function of the distortion characteristic function of the power amplifier. In this case, the distortion compensation unit 120 may be configured to multiply the compensation function by the OFDM signal from the RF receiving unit 110 to compensate for the distortions.

In this case, when the distortion characteristic function of the power amplifier is set to be ‘f(x)’ as in the following Equation 1 and the compensation function is set to be ‘f′(x)’ as in the following Equation 2, the ‘f′(x)’ may be ax/f(x). Here, ‘a’ may be a slope of a primary function for ‘x’.

In this case, when multiplying the compensation function ‘f′(x)’ by the distortion characteristic function ‘f(x)’, the compensated signal depending on the following Equation 3 has only ‘ax’ and thus, has distortion-compensated linear characteristics.

Equation 1

Distortion Characteristic Function=f(x) 1

Equation 2

Compensation Function=f′(x)=ax/f(x) 2

Equation 3

f(x)*f′(x)=f(x)*ax/f(x)=ax 3

Further, referring to FIG. 1, the distortion compensation unit 120 may include a plurality of pieces of characteristic identification information data for identifying distortion characteristics of various power amplifiers that can be applied to the OFDM transmitter and a code-book having a plurality of compensation functions respectively corresponding to the plurality of pieces of characteristic identification information data.

In this case, when the characteristic identification information included in the OFDM signal is detected, the compensation functions corresponding to the characteristic identification information may be called from the code-book.

Further, referring to FIG. 1, the OFDM receiver may be included in the OFDM base station receiving the RF OFDM signal from the OFDM transmitter, in the OFDM receiver according to the embodiment of the present invention, and it is not limited thereto, and as another example, the OFDM receiver may be applied to an OFDM terminal.

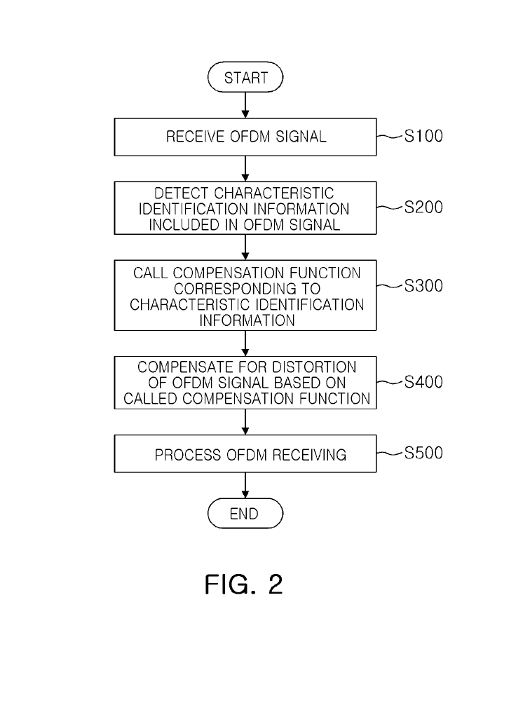

FIG. 2 is a flowchart illustrating a signal processing method of the OFDM receiver according to the embodiment of the present invention.

Referring to FIGS. 1 and 2, the signal processing method of the OFDM receiver according to the embodiment of the present invention may include (a) converting an RF OFDM signal received from the OFDM transmitter into the OFDM signal (S100), (b) detecting the characteristic identification information included in the received OFDM signal so as to recognize a type of distortion characteristic of the power amplifier included in the OFDM transmitter (S200), (c) calling a preset compensation function so as to correspond to the detected characteristic identification information (S300), and (d) compensating for the distortions of the received OFDM signal by using the called compensation function (S400).

In this case, in operation (a) (S100), the RF receiving unit 110 of the OFDM receiver 100 may convert the RF OFDM signal received from the OFDM transmitter into the OFDM signal.

In operation (b) (S200), in order for the distortion compensation unit 120 of the OFDM receiver 100 to recognize the type of distortion characteristic of the power amplifier included in the OFDM transmitter, the characteristic identification information included in the received OFDM signal may be detected.

In operation (c) (S300), the distortion compensation unit 120 of the OFDM receiver 100 may call the preset compensation function to correspond to the detected characteristic identification information.

In operation (d) (S400), the distortion compensation unit 120 of the OFDM receiver 100 may compensate for the distortions of the received OFDM signal by using the called compensation function.

In addition, in operation (e) (S500), an OFDM receiving unit 130 of the OFDM receiver 100 may perform the OFDM processing on the distortion-compensated OFDM signal.

In addition, referring to FIGS. 1 and 2, the received OFDM signal may include one of the plurality of pieces of characteristic identification information data for identifying the distortion characteristic functions of the power amplifier included in the OFDM transmitter.

For example, when the distortion characteristics of the power amplifier applied to the OFDM transmitter are classified into type A distortion characteristics, type B distortion characteristics, and type C distortion characteristics, the characteristic identification information capable of identifying the type A distortion characteristics, the type B distortion characteristics, and the type C distortion characteristics may be added to the OFDM signal.

Further, referring to FIGS. 1 and 2, the compensation function may be set to an inverse function of the distortion characteristic function of the power amplifier, and in operation (d) (S400), the distortions may be compensated by multiplying the compensation function by the received OFDM signal.

In this case, when the distortion characteristic function of the power amplifier is set to be ‘f(x)’ as in the above Equation 1 and the compensation function is set to be ‘f′(x)’ as in the above Equation 2, the ‘f′(x)’ maybe ax/f(x). Here, ‘a’ may be a slope of a primary function for ‘x’.

In this case, when multiplying the compensation function ‘f′(x)’ by the distortion characteristic function ‘f(x)’, the compensated signal depending on the above Equation 3 has only ‘ax’ and thus, has distortion-compensated linear characteristics.

In operation (d) (S400), the plurality of pieces of characteristic identification information data for identifying the distortion characteristics of various power amplifiers that can be applied to the OFDM transmitter, and the code-book having the plurality of compensation functions respectively corresponding to the plurality of pieces of characteristic identification information data, may be used. Here, the code-book may be included in the distortion compensation unit 120.

In this case, when the distortion compensation unit 120 detects the characteristic identification information included in the OFDM signal, the compensation function corresponding to the characteristic identification information may be called from the code-book.

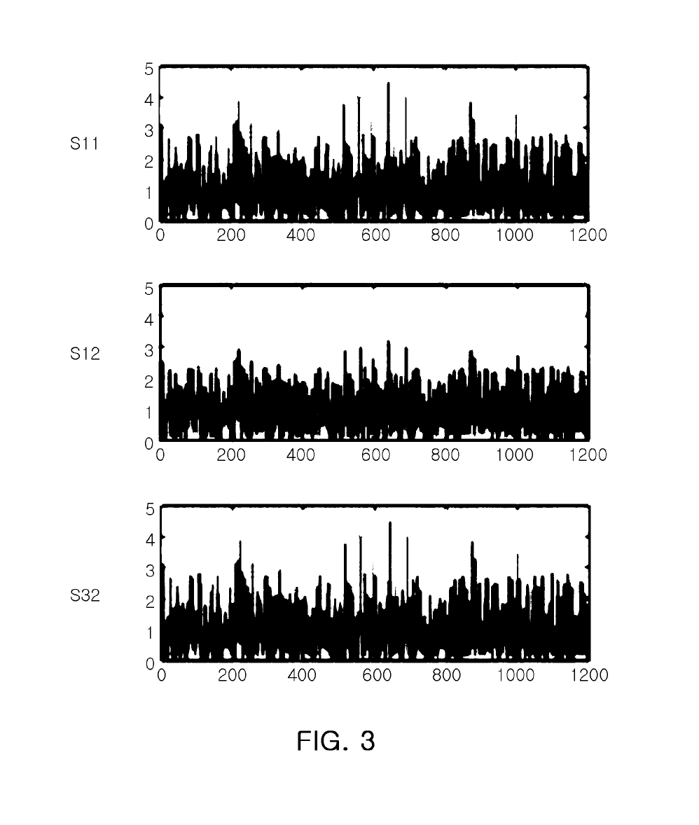

FIG. 3 is a waveform diagram of an OFDM signal according to the embodiment of the present invention.

In FIG. 3, S11 is a waveform of the OFDM signal provided from the OFDM transmitting unit 11 and S12 is a waveform of the OFDM signal provided from the power amplifier 12. Further, S32 is the waveform of the OFDM signal provided from the distortion compensation unit 120.

Referring to FIG. 3, even when like the OFDM signal S12, the OFDM signal S11 is distorted in the power amplifier 12, when observing the distortion-compensated OFDM signal S32 in the OFDM receiver according to the embodiment of the present invention, it can be appreciated that the distortion of the OFDM signal S32 may be compensated like the OFDM signal S11 before being distorted.

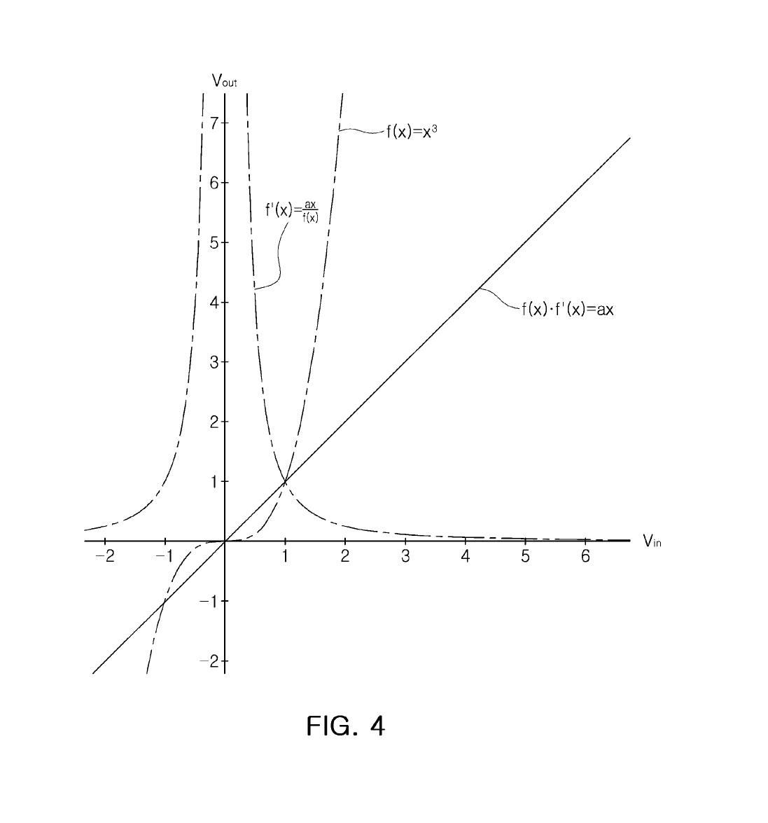

FIG. 4 is a graph illustrating the distortion characteristic functions and the compensation functions according to the embodiment of the present invention.

Referring to FIG. 4, when the distortion characteristic function of the power amplifier is set to be ‘f(x)’ as in the above Equation 1 and the compensation function is set to be ‘f′(x)’ as in the above Equation 2, the compensation function ‘f′(x)’ may be ax/f(x). Here, ‘a’ may be a slope of a primary function for ‘x’.

In this case, when multiplying the compensation function ‘f′(x)’ by the distortion characteristic function ‘f(x)’, the compensated signal depending on the above Equation 3 has only ‘ax’, such that it can be appreciated from the graph shown in FIG. 4 that the compensated signal has the distortion-compensated linear characteristics.

As set forth above, according to embodiments of the present invention, the amount of side information corresponding to the information other than the pure data may be reduced as compared with the PAPR reduction technique according to the related art by simply compensating for the distortions of the OFDM signal in the OFDM receiver using the distortion characteristics of the power amplifier included in the OFDM transmitter, thereby preventing a deterioration in performance due to the PAPP, reducing the complexity of the system, preventing the delay of the OFDM signal, reducing system implementation costs, and expanding the operating area of the power amplifier.

While the present invention has been shown and described in connection with the embodiments, it will be apparent to those skilled in the art that modifications and variations can be made without departing from the spirit and scope of the invention as defined by the appended claims.

What is claimed is:

1. An orthogonal frequency division multiplexing (OFDM) receiver, comprising:
an RF receiving unit converting an RF OFDM signal received from an OFDM transmitter into an OFDM signal;
a distortion compensation unit including a plurality of preset compensation functions for respective pieces of data among a plurality of pieces of characteristic identification information data for identifying distortion characteristic functions of a power amplifier included in the OFDM transmitter and compensating for distortions of the OFDM signal from the RF receiving unit by using a compensation function corresponding to a respective piece of data of the characteristic identification information data included in the OFDM signal from the RF receiving unit among the plurality of compensation functions; and
an OFDM receiving unit processing the OFDM signal of which distortions contained therein are compensated by the distortion compensation unit.

2. The OFDM receiver of claim 1, wherein the OFDM signal received in the RF receiving unit includes a single corresponding characteristic identification information datum among the plurality of pieces of characteristic identification information data for identifying the distortion characteristic functions of the power amplifier included in the OFDM transmitter.

3. The OFDM receiver of claim 1, wherein the compensation function is set to an inverse function of the distortion characteristic function of the power amplifier, and the distortion compensation unit compensates for distortions by multiplying the compensation function by the OFDM signal from the RF receiving unit.

4. The OFDM receiver of claim 2, wherein the distortion compensation unit has the plurality of pieces of characteristic identification information data for identifying the distortion characteristics of various power amplifiers applicable to the OFDM transmitter and a codebook having the plurality of compensation functions respectively corresponding to the plurality of pieces of characteristic identification information data.

5. The OFDM receiver of claim 1, wherein the OFDM receiver is included in an OFDM base station receiving an RF OFDM signal from the OFDM transmitter.

6. A signal processing method of an OFDM receiver, comprising:
(a) converting an RF OFDM signal received from an OFDM transmitter into an OFDM signal;
(b) detecting characteristic identification information included in the received OFDM signal so as to recognize a type of distortion characteristic of a power amplifier included in the OFDM transmitter;
(c) calling a preset compensation function so as to correspond to the detected characteristic identification information; and
(d) compensating for distortions of the received OFDM signal by using the called compensation function.

7. The signal processing method of claim 6, further comprising: performing OFDM processing on the distortion-compensated OFDM signal.

8. The signal processing method of claim 6, wherein the received OFDM signal includes a single corresponding characteristic identification information datum among a plurality of pieces of characteristic identification information data for identifying distortion characteristic functions of the power amplifier included in the OFDM transmitter.

9. The signal processing method of claim 6, wherein the compensation function is set to an inverse function of the distortion characteristic function of the power amplifier, and in operation (d), the distortions are compensated by multiplying the compensation function by the received OFDM signal.

10. The signal processing method of claim 6, wherein operation (d) is performed using the plurality of pieces of characteristic identification information data for identifying the distortion characteristics of various power amplifiers applicable to the OFDM transmitter and a codebook having the plurality of compensation functions respectively corresponding to the plurality of pieces of characteristic identification information data.
